(19) United States
(12) Patent Application Publication
(10) Pub. No.: US 2021/0339302 A1
(43) Pub. Date: Nov. 4, 2021

(54) METHOD FOR OPERATING A BENDING MACHINE

(71) Applicant: TRUMPF Maschinen Austria GmbH & Co. KG., Pasching (AT)

(72) Inventors: Gerhard ANGERER, Altenberg (AT); Klemens FREUDENTHALER, Linz (AT); Florian HAUSMANN, Traun (AT); Matthias HOERL, Linz (AT); Nenad KOVJENIC, Linz (AT); Florian MAIER, Leonding (AT); Michael SCHERNHAMMER, Leonding (AT); Verena STEININGER, Linz (AT); Helmut THEIS, Pfarrkirchen (AT)

(73) Assignee: TRUMPF Maschinen Austria GmbH & Co. KG., Pasching (AT)

(21) Appl. No.: 17/271,655

(22) PCT Filed: Aug. 26, 2019
(86) PCT No.: PCT/AT2019/060270

§ 371 Date: Feb. 26, 2021

(30) Foreign Application Priority Data
Aug. 28, 2018 (AT) A 50734/2018

(51) Int. Cl. B21D 5/00; B21D 5/02; G05B 19/4068

(52) U.S. Cl. CPC B21D 5/004; B21D 5/02; G05B 2219/45143; G05B 2219/35287; G05B 19/4068

(57) ABSTRACT

The invention relates to a method for producing a component by forming a workpiece (5) from sheet metal with a bending machine (1) having a control device (10) and a manufacturing program (14) for operating the bending machine (1), wherein in a processing area (18) at least two manufacturing steps each with a bending formation are carried out on the workpiece (5), and wherein the processing area (18) is recorded by a camera (16, 17), and images of the processing area (18) are displayed to the operator (20) by a display means (19), and, wherein during the performance of a first manufacturing step, working instructions for a subsequent phase of the current, first manufacturing step or for a subsequent, second manufacturing step are superimposed by an image processing program (15) on the images of the processing area (18) to be displayed by the display means (19) and are displayed by the display means (19).

The invention relates to a method of producing a component by forming a workpiece from sheet metal with a bending machine, according to the preamble of claim 1.

When manufacturing complex components with a bending machine or bending press, an operator performs several bending operations successively on a workpiece in a suitable sequence. Such bending machines for so-called free bending but also for embossing bending are equipped with two press beams aligned parallel to each other, to which bending tools arranged in pairs are attached. Several bending stations equipped with different bending tools can also be provided along the length of the press beams. The respective bending operation is performed by positioning the workpiece between the bending tools and then bending it by pressing the press beams against each other. The operator places the workpiece between the bending tools and applying it to the abutments for precise alignment. Corresponding bending tools—lower tool and upper tool—are also referred to as female die and male die.

Bending operations are performed in an analogous manner on a bending machine for swivel bending. The workpiece or sheet metal part is inserted between a lower and an upper retaining cheek, aligned at abutments and clamped by pressing the retaining cheeks together. Bending operation is then performed by a bending tool which acts on the free leg of the workpiece protruding from the retaining cheeks.

Modern bending presses or manufacturing devices also provide control devices by which the machine settings of the sequence of manufacturing steps are program-controlled. For example, the abutments are operated by a motor, whereby they are repositioned by the control device in accordance with the commands of a manufacturing program. With the aid of such controls, semi-automatic operation of the bending machines is possible—based on a corresponding manufacturing program. For this purpose, it is usual for an operator to place the workpiece in the bending press by placing it onto the lower tool and applying it to the abutments. Triggered by the actuation of a switch, for example a foot switch, the press beams are then moved together and the workpiece is formed. The adjustment or repositioning of the abutments for a subsequent manufacturing step is then carried out automatically on the basis of the manufacturing program stored in the control system.

The manufacturing steps for performing a bending operation are divided into several phases, such as positioning the abutments, inserting the workpiece by placing it onto the lower tool and applying it to the abutments, pressing the upper tool down against the workpiece and the lower tool, raising the upper tool, and finally removing the workpiece from the machine. In a subsequent manufacturing step, the abutments are then repositioned again and the further phases are carried out with a further bending formation on the newly inserted workpiece.

Despite the support provided to the operator by the program-based control device, the machine operator still has to coordinate and monitor a wide variety of actions. In particular, the re-alignment of the workpiece and insertion into the correct bending station and the correct application of the workpiece to the abutments require a corresponding routine on the part of the operator. In the case of series production of a larger number of workpieces to be processed in the same way, this problem is less serious. Rejects due to faulty operation or time delays at the start of a series production are naturally less significant here. This is not the case for small series with a low number of pieces, where operating errors can cause a high proportion of rejects. Applying the workpiece to the abutments precisely and without errors can be considerably impeded due to the limited visibility through the bending tools. Solutions are already known in the state of the art for this purpose by attaching cameras which record the rear part of the processing area—from the operator's point of view—and display an image of this to the operator at the front of the press beam. In particular, it is also possible to transform the perspective of the image before projecting it onto the front of the press beam in such a way that it appears to be seamlessly superimposed on the operator's field of view. The operator thus sees the front part of the processing area in his field of view, supplemented by a virtual representation of the part of the processing area behind the pressing beam.

It is the object of the present invention to provide a method and apparatus for manufacturing a component by forming a workpiece from sheet metal, by means of which the work for the operator is simplified and the risk of operating errors can be further reduced.

This object of the invention is solved by a method for producing a component by forming a workpiece from sheet metal with a manufacturing device with two press beams aligned parallel to one another, with bending tools attached to the press beams and with a control device and a manufacturing program for operating the manufacturing device, wherein at least two manufacturing steps, each with a bending formation of the workpiece, are carried out in a processing area. In this case, the processing area is detected by at least one camera and images of the processing area are displayed to the operator by a display means, wherein during the execution of a first manufacturing step, working instructions for a subsequent phase of the current, first manufacturing step or for a subsequent, second manufacturing step are superimposed by an image processing program on the images to be displayed by the display means and are displayed by the display means. This has the advantage that the operator does not need to interrupt the observation and thus visual monitoring of the processes in the current bending station in order to obtain information about the subsequent_manufacturing steps, for example from the screen of the operator terminal.

Advantageous are also the embodiments of the method, whereby the working instruction contains symbols from a group, comprising lines, arrows and bars, or, if the working instruction contains symbols from a group, comprising rotation axes and value specifications of rotation angles. In this way, movements to be performed with the workpiece and changes in position for operating the bending press can be represented pictorially in a simple manner.

It is also advantageous if the working instruction contains a graphic representation of the workpiece, as this makes it easy to communicate changes in the workpiece alignment in an easily comprehensible manner.

The further embodiment, whereby the working instruction contain a symbol pointing to a specific location on the workpiece to indicate a preferred point of engagement for removing the workpiece, has the advantage that delays in removing the workpiece can thereby be avoided. The increasing complexity of the geometric shape of the workpiece—as a result of the increasing number of bending formations performed on the workpiece—can in fact make its removal more difficult due to the space between the two bending tools.

It is also advantageous if the working instruction contains a symbol to indicate a warning due to an operating error, as this might increase both safety and possibly minimize resulting scrap.

The further embodiments of the method, wherein the working instruction contains a graphic representation of the workpiece in motion, or wherein the working instructions contain graphic representations of abutments for aligning the workpiece in motion, have the advantage of particular clarity for the operator.

It is also advantageous if the graphic representation of the workpiece that is moved during a temporal duration of the presentation of the work instruction is repeatedly displayed one after the other, since this allows the operator to better grasp the necessary information.

If the temporal duration of the presentation of the working instruction is started before the end of the phase of moving the press beams apart or if the temporal duration of the presentation of the working instructions is started already together with the end of the first bending formation, the operator can be instructed as early as possible about the further manufacturing phases or manufacturing steps and operating actions.

It is also advantageous if the temporal duration of the presentation of the working instruction is completed together with the start of the second bending formation of the subsequent_manufacturing step, as this does not interfere with the operator's visual monitoring of the bending process.

It is also advantageous that, in order to determine the spatial coordinates of the operator, images from a camera arranged on a front side of the upper press beam are evaluated by the position determination system.

It is also advantageous if the control device includes an image recognition program and the start of the bending formations is performed automatically after the end of the phase of inserting the workpiece into the bending station is detected, as this makes operation even easier.

For a better understanding of the invention, it is explained in more detail with reference to the following figures.

Each of them shows in highly simplified, schematic representation:

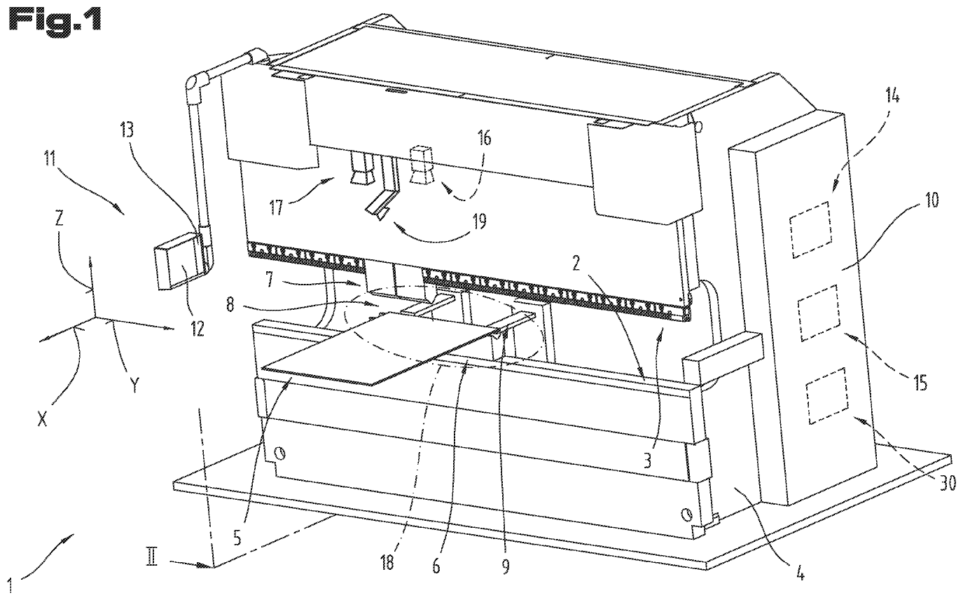

FIG. 1 a bending press for performing a bending formation on a workpiece;

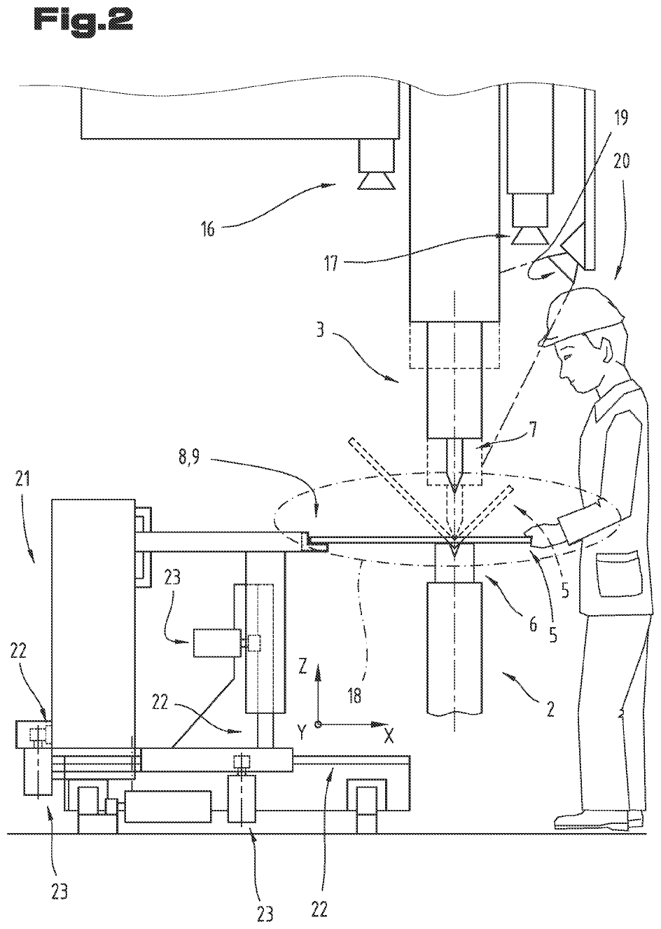

FIG. 2 a cross-section of the bending press of FIG. 1;

FIG. 3 an image of the processing area displayed by an operator display means;

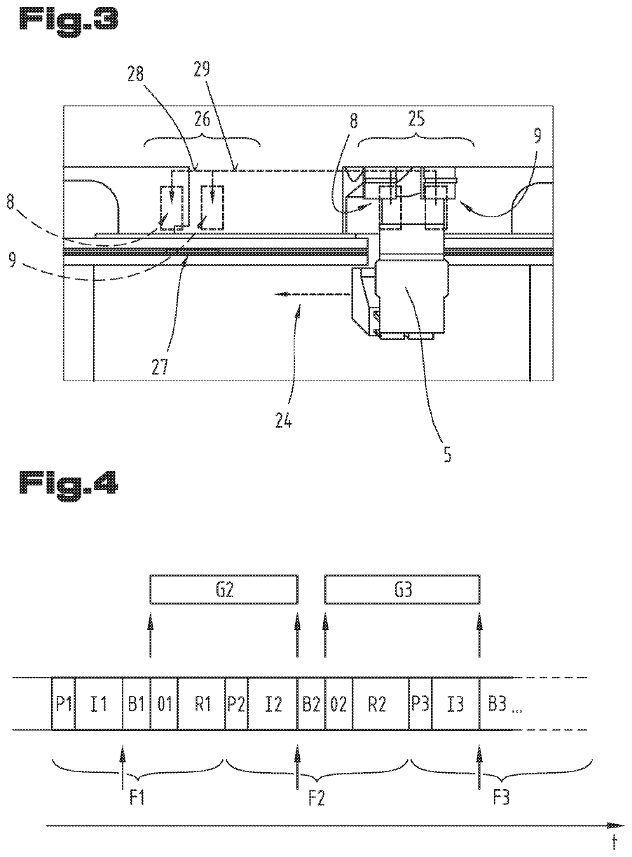

FIG. 4 a time sequence diagram of the processing of a workpiece with the bending press;

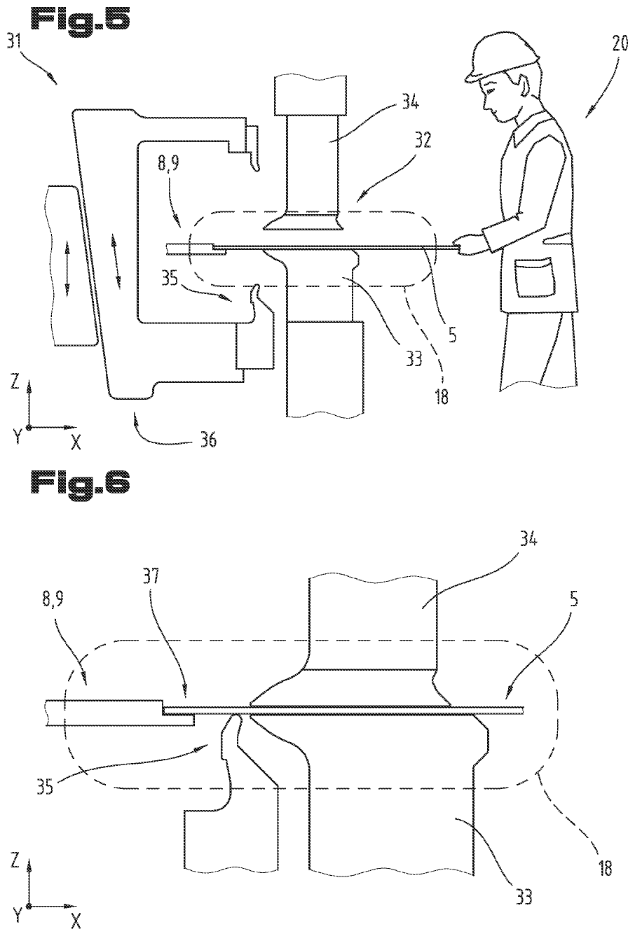

FIG. 5 a bending machine for swivel bending shown in side view and in sectional view;

FIG. 6 a detail of the bending machine for swivel bending according to FIG. 5;

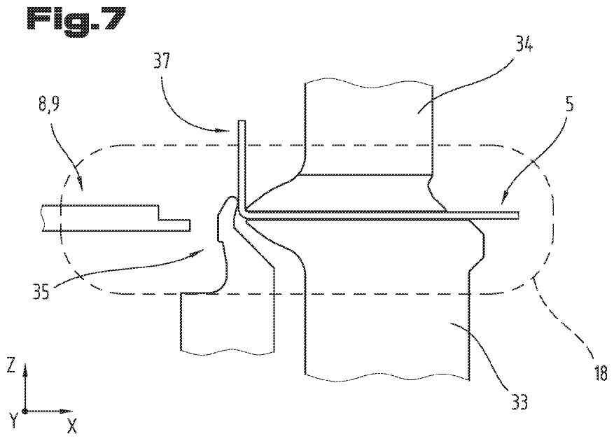

FIG. 7 a detail of the bending machine for swivel bending according to FIG. 5 after the execution of the bending formation of the workpiece.

By way of introduction, it should be noted that in the differently described embodiments, the same parts are provided with the same reference signs or the same component designations, whereby the disclosures contained in the entire description can be transferred mutatis mutandis to the same parts with the same reference signs or the same component designations. Also, the positional indications selected in the description, such as top, bottom, side, etc., are related to the directly described as well as depicted figure, and these positional indications are to be transferred mutatis mutandis to the new position in the event of a change of position.

FIG. 1 shows a bending press 1 as an example of a manufacturing device or workpiece processing machine. In a known manner, the bending press 1 has a lower press beam 2 and an upper press beam 3. The two press beams 2, 3 are held by a machine frame 4, the lower press beam 2 being fixed, i.e. stationary, to the machine frame 4. The lower, fixed press beam 2 is therefore also often referred to as a table beam. The upper press beam 3, on the other hand, is guided on the machine frame 4 so as to be adjustable in the vertical direction (Z-direction). With the aid of a suitable motorized drive, for example with the aid of hydraulic cylinders (not shown), the upper press beam 3 can be lowered towards the lower press beam 2. To perform a bending formation on a workpiece 5, a lower bending tool 6 (a female die) and an upper bending tool 7 (a male die) are attached in pairs to each of the two press beams 2, 3. A bending formation is then performed on the workpiece 5 by moving the two press beams 2, 3 against each other, whereby the upper bending tool 7 (abbreviated to “upper tool”) is pressed against the workpiece 5 and the lower bending tool 6 (abbreviated to “lower tool”) until the desired degree of formation of the workpiece 5 is achieved.

In addition to the bending tools 6, 7, which effect the actual bending formation and act on the workpiece 5 through the relative adjustment of the press beams 2, 3, the bending press 1 also comprises one or more abutments 8, 9, to which edges or sides of the workpiece 5 can be applied and thus aligned. The abutments 8, 9 are usually also referred to as “rear abutments” because, from the point of view of an operator standing in front of the bending press 1, these are arranged behind the press beams 2, 3. After appropriate positioning of the abutments 8, 9 relative to the bending tools 6, 7, an operator can perform bending or canting on the workpiece 5 very easily and yet with great accuracy.

To operate the bending press 1, it is provided with a control device 10 and an operating terminal 11. The operating states of the bending press 1 can be displayed to an operator on a screen 12 of the operating terminal 11 and it is thus possible for the operator to prepare manufacturing steps to be carried out with the bending press 1 via an input device 13. This preparation of a new manufacturing step can, for example, consist of repositioning the abutments 8, 9. For this purpose, the abutments 8, 9 are adjustable in a motor-driven way and the operator can cause the repositioning of the abutments 8, 9, for example by directly entering the new coordinates.

Usually, the machine settings required for the individual manufacturing steps are stored in a manufacturing program 14 in the control device 10. The operator can request the manufacturing program 14 at the operating terminal 11 and can display it. The corresponding manufacturing steps can be selected and the setting of the new operating state of the bending press 1 can be started. After insertion of the workpiece 5, i.e. placing the workpiece 5 onto the lower tool 6 and applying it to or onto abutting surfaces of the abutments 8, 9, the bending formation can then be started by moving the press beams 2, 3 against each other. In conventional bending presses, a separate switch, for example formed by a foot switch, is provided to the operator for this purpose. By actuating the switch, the operator can control the pressing down and raising the upper press beam 3.

The control device 10 of the bending press 1 according to this embodiment example is also formed with an image processing program 15. Furthermore, at least one camera 16 is arranged at least behind the press beams 2, 3—as seen by an operator standing in front of the bending press 1. Preferably, an additional camera 17 is also arranged in front of the upper press beam 3. The camera 16 arranged behind the upper press beam 3 is directed at a processing area 18 in the vicinity of the bending tools 6, 7 or the workpiece 5. The upper bending tools 7 and the upper press beam 3 limit the field of view that can be captured by the camera 16, which can only record a rear part of the processing area 18. Images supplied by the camera 16 can be used, preferably after processing in the image processing program 15, to show an operator a larger, i.e. in particular an otherwise inaccessible part of the processing area 18 and thus make it visible. This is done, for example, by arranging a display means 19 on the front side of the upper press beam 3 facing the operator. The display means 19 is preferably a display arranged in the area of the front side of the upper press beam 3. Alternatively, a projector can also be used as display means 19 (FIG. 1, 2). Such a projector can project images recorded by the camera 16 onto the front side of the upper press beam 3 and the upper bending tool 7.

The images of the camera 16 can be transformed in perspective by the image processing program 15 before being displayed by the display means 19. Such a method is described, for example, in the Austrian patent AT 518 890 B1. In which, for example with the front camera 17, the spatial position of the head or the eyes of the operator (FIG. 2) are also determined, the images of the camera 16 can be transformed in perspective with the aid of the image processing program 15 in such a way that the rear part of the processing area 18 appears to the operator seamlessly in his field of view. For the transformation, the spatial coordinates of the camera 16, the coordinates of the processing area 18 and the coordinates of the position of the operator or the operator's head are also taken into account by the image processing program 15.

FIG. 2 shows a side view or cross-section of the bending press 1 according to FIG. 1. The two abutments 8, 9 are respectively attached to an abutment device 21 and can be adjusted and thus repositioned in the three spatial directions X, Y, Z with the aid of the latter. For this purpose, the stop devices 21 have guideways 22 directed in the X, Y and Z directions and interacting servomotors 23 for adjusting the abutments 8, 9. The workpiece 5 (a sheet metal part) is inserted by an operator 20 into the processing area 18 between the lower bending tool 6 and the upper bending tool 7 and aligned at the two abutments 8, 9.

FIG. 2 shows the workpiece 5 and the bending press 1, respectively, at two different times of two successive phases of a first manufacturing step F1 of producing a component from the workpiece 5. The position of the unformed workpiece 5—shown in solid lines—corresponds to the time of the end of the phase “inserting the workpiece into the processing area and applying it to the abutments”. The position of the workpiece 5 in the bent state—shown in dashed lines—corresponds to the time of the end of the bending formation or the end of the phase “pressing upper tool 7 against workpiece 5 and lower tool 6”.

The first manufacturing step F1—analogously also each further manufacturing step F2, F3, etc.—can be divided into at least five phases or measures. These phases are:

P1: Positioning the abutments 8, 9 to align the workpiece 5 in the processing area 18;

I1: Inserting the workpiece 5 into the processing area 18 by placing it onto the lower tool 6 and applying or resting the workpiece 5 t the abutments 8, 9;

B1: Performing the bending formation by pressing the upper tool 7 against the workpiece 5 and the lower tool 6 by moving the press beams 2, 3 against each other;

O1: Moving the press beams 2, 3 apart;

R1: Removing the workpiece 5 from the lower tool 6.

Preferably from the time of the end of the first bending formation B1 (FIG. 4) of the workpiece 5, the operator 20 can also be displayed by the display means 19—together with the image of the camera 16 of the rear part of the processing area 18—additional information or instructions on the further course of the processing of the workpiece 5. For this purpose, in the image processing program 15 pictorially or graphically representable indications of subsequent phases of the current and the subsequent manufacturing step F2 are generated and these are superimposed on the images from the camera 16. The images thus enriched with work instructions are then projected by the display means 19 into the operator's field of view 20.

The work instructions superimposed on the images and displayed by the display means 19 are, for example, lines or arrows with which directions and movements or positions of subsequent manufacturing steps F2, F3 are symbolically indicated. The operator 20, whose gaze is directed to the processing area 18, thus sees in his field of view simultaneously also a presentation of live images of the rear part of the processing area 18, which otherwise would not be visible, and—superimposed on the live images—work instructions for future phases of the current manufacturing step F1 or of the subsequent manufacturing step F2.

FIG. 3 shows an image of the processing area 18 displayed by the display means 19 of the operator 20 with working instructions superimposed on this image. Such a working instruction is formed, for example, by an arrow 24 by which the direction of movement of the workpiece 5 from a current, first bending station 25 to a next, second bending station 26 of the subsequent manufacturing step is indicated. A bar 27 indicates the position of the bending tools 6, 7 of the subsequent bending station 26. Further arrows 28, 29 indicate the travel paths or the positions of the back abutments 8, 9 for their change from the first bending station 25 of the first manufacturing step F1 to the second bending station 26 of the subsequent, second manufacturing step F2. The operator 20 is thus already informed during the course of the first manufacturing step F1 to which next bending station 26 the workpiece 5 is to be moved after its removal from the currently current bending station 25. By displaying this information in this way, together with the image from the camera 16 and superimposed on the field of view of the operator 20, the operator 20 does not need to turn away from the current bending station 25 in order to obtain information about the subsequent manufacturing steps, for example from the screen 12 of the operator terminal 11. This allows the operator 20 to keep his or her gaze directed substantially uninterruptedly at the processing area 18 and to monitor the events occurring therein without interruption. The indication of the travel paths of the abutments 8, 9 by means of the arrows 28, 29 also makes it easier for the operator 20 to avoid a collision of the workpiece 5 with the moving abutments 8, 9 during the change between the bending stations 25, 26. This is particularly useful because the adjusting movements of the abutments 8, 9 are sometimes made at very high speed.

FIG. 4 shows a time sequence diagram of the manufacturing program 14 for manufacturing a component from the workpiece 5 using the bending press 1. According to this embodiment example, the manufacturing program 14 comprises three manufacturing steps F1, F2 and F3 that follow temporarily one after the other. Each one of these manufacturing steps F1, F2, F3 comprises the following phases:

P: Positioning the abutments 8, 9;

I: Inserting the workpiece 5;

B: Performing the bending formation;

O: Moving the press beams apart and

R: Removing the workpiece 5.

In addition to the schematic representation of the phases P, I, B, O, R of the successive manufacturing steps F1, F2, F3, the time sequence diagram of FIG. 4 also shows phases in which additional work instructions are displayed to the operator 20 standing in front of the bending station 25, 26 of the bending press 1 in his field of view. Thus, starting at a point in time even before the end of the first manufacturing step F1, in a phase G2 a superimposition of additional work instructions on the image taken by the camera 16 is displayed to the operator 20 in his field of view by the display means 19.

The sequence of the manufacturing program 14, which can be started by the operator, for example, with the aid of the operator terminal 11, thus takes place in the following manner. At the beginning of the first manufacturing step F1 of the manufacturing program 14, the positioning P1 of the abutments 8, 9 in the first bending station 25 is first performed, whereupon the operator 20 inserts the workpiece 5 into the processing area 18 and applies it to the abutments 8, 9 (phase I1). After end of phase I1 of inserting the workpiece 5, the operator 20 can start the bending formation B1. This is done, for example, with a switch formed by a foot switch. The bending formation B1 is carried out by pressing the upper tool 7 against the workpiece 5 and the lower tool 6 by moving the two press beams 2, 3 against each other. The movement of the press beams 2, 3 takes place automatically based on specifications in the manufacturing program 14. All that remains for the operator 20 is to wait for the press beams 2, 3 to move apart (phase O1) and to remove the workpiece 5 from the first bending station 25 (phase R1).

Even during these last two phases O1, R1 of the first manufacturing step F1, the operator 20 receives information or instructions about the subsequent_phases or manufacturing steps in the processing sequence. These are displayed to the operator 20 by the display means 19 in his field of view as a superimposition on the images taken by the camera 16. While the operator 20 is still observing the bending formation B1 that is currently being carried out, he is also shown a working instruction G2 with information about the course of the subsequent manufacturing step F2. This working instruction G2 may contain graphic elements, as described above in connection with the description of FIG. 3. Thus, the working instruction G2 preferably comprises the arrow 24 indicating the direction to the subsequent bending station 26 to which the workpiece 5 must be moved. Likewise, already during phases O1 and R1, the two arrows 28, 29 can indicate the movements of the back abutments 8, 9 towards the subsequent bending station 26, as they will only occur in phase P2 of the subsequent manufacturing step F2.

The presentation of the working instruction G2, which takes place in parallel with the manufacturing steps F1 and F2, is preferably continued until both the positioning P2 of the back abutments 8, 9 and the insertion of the workpiece 5 into the next bending station 26 for the second manufacturing step F2 have been completed. Only with the start of the second bending formation B2 of the second manufacturing step F2, initiated by the operator 20, is the presentation of the working instructions G2 terminated. In analogous manner, as described above for the first manufacturing step F1, the presentation of additional working instructions G3 for the further course of the subsequent, third manufacturing step F3 is already carried out before the end of the second manufacturing step F2.

If necessary, the working instruction G3 may also comprise only a repositioning of the back abutments 8, 9 if the following third manufacturing step F3 is to be carried out at the same bending station 26 as the previous manufacturing step F2. On the other hand, the representation of the working instruction G3 may also include additional instruction for the operator 20 with respect to the way in which the formed workpiece 5 can be conveniently removed from the processing area 18 or the bending station 25, 26. Thus, due to the increasing complexity of the geometric shape of the workpiece 5—as a result of the increasing number of bending formations performed on this workpiece 5—its removal from the bending station 25, 26 could require a special type of handling. The operator 20 is informed of this circumstance by the fact that the working instructions G3 also contain, for example, a symbol pointing to a specific location on the workpiece 5 which indicates a preferred point of engagement for easier removal of the workpiece 5 from the bending station 25, 26. For example, an image of a hand is used as such a symbol to indicate how the workpiece 5 should be grasped at a particular point.

According to a preferred further embodiment of the bending press 1, it is provided in its image processing program 15 that the work instructions G2, G3 also contain animated movement sequences showing the workpiece 5 as it is moved from its removal from the first bending station 25 of the first manufacturing step F1 towards the second bending station 26 and during insertion in phase I2 of the subsequent manufacturing step F2. Preferably, this animatedly represented movement of the workpiece 5 is repeatedly presented to the operator 20 several times in succession over the duration of the phase of presentation of the work instruction G2, G3. The repeated presentation of these movement sequences during the presentation of the working instructions G2, G3 is only terminated by starting the phase of the respective subsequent bending formation B2, B3.

The handling of the workpiece 5 by the operator 20 in preparation for the respective subsequent_manufacturing step F2, F3 can be additionally facilitated by the fact that the working instructions G2, G3 also contain instructions for the realignment of the workpiece 5. Such indications can be indicated, for example, by the additional representation of rotary axes and corresponding angular values. The coordinate axes of the commonly used Cartesian coordinate system X, Y, Z (FIGS. 1, 2) are particularly suitable as such rotational axes. The indication or instruction for the realignment of the workpiece 5 in the working instruction G2, G3 can also be indicated by a succession of rotations about different rotational axes to be performed one after the other.

In the above-described embodiment example of the manufacturing device or bending press 1, it was assumed that the start of the phases P1, P2, P3 of positioning the abutments 8, 9 as well as the start of the phases B1, B2, B3 of executing the bending formations is initiated by the operator 20 by actuating a corresponding switch (e.g. a foot switch).

According to an alternative embodiment, it is provided that the control device 10 also comprises an image recognition program 30. With the aid of the image recognition program 30, it is possible to evaluate the images of the processing area 18 recorded by the camera 16 and, in particular, to automatically determine the spatial position and orientation of the workpiece 5. This makes it possible for the image recognition program 30 to recognize the insertion of the workpiece 5 into the processing area 18 and the application of its edges to the abutments 8, 9, and thus to automatically communicate its end to the control device 10. The bending formations in phases B1, B2, B3 can then be started automatically by the control device 10.

By evaluating the images recorded by the camera 16 with the aid of the image recognition program 30, it is also possible in particular to detect an incorrect operation by the operator 20 and to indicate this to the operator. Operating errors, such as the insertion of the workpiece 5 in the wrong bending station 25, 26 or an incorrect alignment of the workpiece 5 when it is inserted in the bending station 25, 26 can thus be additionally displayed in the form of a warning message in the work instructions G2, G3 of the operator 20.

FIG. 5 shows a bending machine 31 for swivel bending in side view and shown in sections.

The bending machine 31 first comprises a retaining device 32 with a lower retaining cheek 33 and an upper retaining cheek 34, between which the workpiece 5 can be clamped for processing. This is usually done by lowering and pressing the upper retaining cheek 34 against the interposed workpiece 5 and the lower retaining cheek 33. A bending tool 35 is provided for bending formation. The bending tool 35 is attached to a tool carrier 36 and can be adjusted in at least two spatial directions (X, Z) with the aid of the tool carrier 36. Forming of the workpiece 5 can be achieved in swivel bending by the bending tool 35 being moved by the tool carrier 36, which is moved by an adjusting drive, against a free leg 37 of the workpiece 5 projecting from the retaining cheeks 33, 34 and acting on the latter while executing a suitable adjusting movement (FIGS. 6, 7). The corresponding path coordinates or path movement data for the movement of the tool carrier 36 with the adjusting drive (not shown) are generated by the control device 10 under specification by the manufacturing program 14. The bending tool 35 pressing against the leg 37 of the workpiece 5 finally causes the desired bending formation of the workpiece 5 (FIG. 7).

In a manner analogous to that described above with reference to FIGS. 1 and 2 of the bending machine 1 for free bending, at least one camera 16 for detecting the processing area 18 is also provided in the bending machine for swivel bending 31. Likewise, the abutments 8, 9 for aligning the workpiece 5 are adjustable by the control device 10 on the basis of corresponding control signals of the manufacturing program 14 for executing different, successive manufacturing steps F1, F2, F3, etc.

FIG. 6 shows a detail of the bending machine 31 for swivel bending with a still unprocessed workpiece 5 at the beginning of the first bending formation. The workpiece 5 is aligned with one of its edges applied to the abutments 8, 9 and clamped between the retaining cheeks 33, 34. The bending tool 35 is located adjacent to leg 37 of the workpiece 5 in its start position for carrying out the bending formation.

In FIG. 7, the workpiece 5 is shown after end of the first bending formation (phase B1 of the first manufacturing step F1). The angled shape of the leg 37 of the workpiece 5 is the result of a correspondingly executed movement path of the bending tool 35. After lifting the upper retaining cheek 34, the workpiece 5 can then be removed from the processing station by the operator 20.

Producing a component by a succession of several bending formations on the workpiece 5 can be carried out by the operator 20 with the bending machine 31 for swivel bending also supported by the control device 10 or its manufacturing program 14. Each of the sequential manufacturing steps F1, F2, F3, etc. comprises the following five phases:

P: Positioning the abutments 8, 9;

I: Inserting the workpiece 5 and clamping it between the lower retaining cheek 33 and the upper retaining cheek 34;

B: Performing the bending formation;

O: Moving part the retaining cheeks 33, 34 and

R: Removing the workpiece 5.

In contrast to the free bending described above, during processing with the bending machine 31 for swivel bending in phase I of inserting the workpiece 5, there is also the additional movement of the retaining cheeks 33 and 34 together to clamp the workpiece 5, which is to be started by the operator 20. For this purpose, a foot switch is usually operated by the operator 20. The subsequent phase B of performing the bending formation can then be carried out automatically following the clamping of the workpiece 5. Alternatively, it can also be provided that the start of phase B of the bending formation requires the operator 20 to actuate the switch again.

The time sequence diagram of the manufacturing program 14 for manufacturing a component from the workpiece 5 with the bending press 31 for swivel bending is otherwise similar to the sequence as shown in FIG. 4. This also applies to the superimposition of work instructions G1, G2, G3 for respective subsequent phases of a current manufacturing step F1 or a subsequent second manufacturing step F2 with the images of the processing area 18 to be displayed on the display means 19.

The embodiment examples show possible embodiment variants, whereby it should be noted at this point that the invention is not limited to the specifically depicted embodiment variants thereof, but rather various combinations of the individual embodiment variants with each other are also possible and this variation possibility is due to the teaching for technical action by the present invention in the skill of those skilled in this technical field.

The scope of protection is determined by the claims. However, the description and the drawings are to be consulted for the interpretation of the claims. Individual features or combinations of features from the different embodiment examples shown and described may constitute independent inventive solutions in their own right. The task underlying the independent inventive solutions can be taken from the description.

All indications of value ranges in the present description are to be understood as including any and all subranges thereof, e.g. the indication 1 to 10 is to be understood as including all subranges starting from the lower limit 1 and the upper limit 10, i.e. all subranges start with a lower limit of 1 or greater and end with an upper limit of 10 or less, e.g. 1 to 1.7, or 3.2 to 8.1, or 5.5 to 10.

Finally, for the sake of order, it should be noted that, for a better understanding of the layout, elements have been shown partially out of scale and/or enlarged and/or reduced in size.

### LIST OF REFERENCE SIGNS

| | |
|---|---|
| 1 | Bending machine |
| 2 | Press beam |
| 3 | Press beam |
| 4 | Machine frame |
| 5 | Workpiece |
| 6 | Bending tool |
| 7 | Bending tool |
| 8 | Abutment |
| 9 | Abutment |
| 10 | Control device |
| 11 | Operating terminal |
| 12 | Screen |
| 13 | Input device |
| 14 | Manufacturing program |
| 15 | Image processing program |
| 16 | Camera |
| 17 | Camera |
| 18 | Processing area |
| 19 | Display means |
| 20 | Operator |
| 21 | Abutment device |
| 22 | Guideway |
| 23 | Servomotor |
| 24 | Arrow |
| 25 | Bending station |
| 26 | Bending station |
| 27 | Bar |
| 28 | Arrow |
| 29 | Arrow |
| 30 | Image recognition program |
| 31 | Bending machine |
| 32 | Retaining device |
| 33 | Lower retaining cheek |
| 34 | Upper retaining cheek |
| 35 | Bending tool |
| 36 | Tool carrier |
| 37 | Leg |

1. Method for producing a component by forming a workpiece (5) from sheet metal with a bending machine (1) having a control device (10) and a manufacturing program (14) for operating the bending machine (1), wherein in a processing area (18) at least two manufacturing steps (F1, F2) each with a bending formation (B1, B2) are carried out on the workpiece (5), and wherein the processing area (18) is recorded by a camera (16, 17) and images of the processing area (18) are displayed to the operator (20) by a display means (19), wherein during the performance of a first manufacturing step (F1), working instructions (G1, G2, G3) for a subsequent phase of the current, first manufacturing step (F1) or for a subsequent, second manufacturing step (F2) are superimposed by an image processing program (15) on the images of the processing area (18) to be displayed by the display means (19) and are displayed by the display means (19).

2. The method according to claim 1, wherein the working instruction (G1, G2, G3) includes symbols from a group comprising lines, arrows and bars.

3. The method according to claim 1, wherein the working instruction (G1, G2, G3) includes symbols from a group comprising rotation axes and value indications of rotation angles.

4. The method according to claim 1, wherein the working instruction (G1, G2, G3) includes a graphical representation of the workpiece (5).

5. The method according to claim 1, wherein the working instruction (G1, G2, G3) includes a symbol pointing to a specific location on the workpiece (5) to indicate a preferred point of engagement for removing the workpiece (5).

6. The method according to claim 1, wherein the working instruction (G1, G2, G3) includes a symbol for communicating a warning due to an operating error.

7. The method according to claim 1, wherein the working instruction (G1, G2, G3) includes a graphic representation of the workpiece (5) in motion.

8. The method according to claim 1, wherein the working instruction (G1, G2, G3) includes graphic representations, in motion, of abutments (8, 9) for aligning the workpiece (5).

9. The method according to claim 1, wherein the graphical representation of the workpiece (5) which takes place in a moving manner during a temporal duration of the presentation of the work instruction (G1, G2, G3) is repeatedly displayed one after the other.

10. The method according to claim 1, wherein the temporal duration of the presentation of the working instruction (G1, G2, G3) is started before the phase (O1) of moving apart the press beams (2, 3) is finished.

11. The method according to claim 1, wherein the temporal duration of the presentation of the working instruction (G1, G2, G3) is started together with the end of the first bending formation (B1).

12. The method according to claim 1, wherein the temporal duration of the presentation of the working instruction (G1, G2, G3) is terminated together with the start of the second bending formation (B2) of the subsequent manufacturing step (F2).

13. The method according to claim 1, wherein for determining the spatial coordinates of the operator (20), images of a camera (17) arranged at a front side of the upper press beam (3) are evaluated by a position determination system.

14. The method according to claim 1, wherein the position of the operator (20) is determined by means of the position determination system, and a respective image with transformed perspective is generated from the images recorded by the camera (16, 17) by the image processing program (15), taking into account coordinates of the camera (16, 17), coordinates of the processing area (18) and coordinates of the position of the operator (20).

15. The method according to claim 1, wherein the control device (10) comprises an image recognition program (30) and the starting of the bending formations (B1, B2) is performed automatically after the end of the phase (I1, I2) of inserting of the workpiece (5) into the bending station (25, 26) is recognized.
